(19) United States
(12) Patent Application Publication
(10) Pub. No.: US 2018/0007265 A1
(43) Pub. Date: Jan. 4, 2018

(54) Closing Device for Sliding Screen Door

(71) Applicant: Ron Crowder, II, Rowland Heights, CA (US)

(72) Inventor: Ron Crowder, II, Rowland Heights, CA (US)

(21) Appl. No.: 15/698,918

(22) Filed: Sep. 8, 2017

Related U.S. Application Data
(63) Continuation-in-part of application No. 14/877,681, filed on Oct. 7, 2015.

(51) Int. Cl. H04N 5/232; H04N 5/247; H04N 5/33

(52) U.S. Cl. CPC H04N 5/23241; H04N 5/332; H04N 5/23245; H04N 5/247

(57) ABSTRACT

A closing device including a tubular cover; a rotating member disposed at least partially inside the cover; a torsion member connected between the cover and the rotating member; and a pulling member at least partially into the cover; the pulling connected to the rotating member; whereby extension of the pulling member away from the cover adjusts a torque in the torsion member to affect a closing. A method of closing a sliding screen door includes attaching the cover to a stationary member and attaching the pulling member to a sliding screen door. The door may be slid to an open position; whereby a torque in the torsion member is increased. The door may then be released; whereby the door is moved from the open position to a closed position by a linear force created in the pulling member through rotation of the rotating member by release of the torque.

### CROSS-REFERENCE TO RELATED APPLICATIONS

This application is a continuation-in-part of U.S. application Ser. No. 14/877,581, filed Oct. 7, 2015, entitled “AUTOMATIC CLOSING DEVICE FOR SLIDING SCREEN DOOR PANEL,” which is herein incorporated by reference in its entirety.

### BACKGROUND

### 1. Field of the Disclosed Subject Matter

This disclosed subject matter relates generally to a closing device and more particularly, but not necessarily exclusively to a closing device for sliding screen doors and methods of use.

### 2. Background

A majority of automated closing devices for sliding screen doors are complicated in nature, permanently attached to the door and/or frame, unbalanced, and do not allow for proper torque adjustment. It is desirable to provide a closing device that overcomes said shortcomings.

### SUMMARY

Some configurations of the disclosed subject matter provide a closing device for closing a sliding screen door. The closing device includes a substantially tubular cover having a rotating member disposed at least partially inside the cover. The device further includes pulling member connected to the rotating member through at least one slit in the cover. The device further includes a torsion member connected between the cover and the rotating member; whereby extension of the pulling member away from the cover adjusts a torque in the torsion member; the torque capable of closing the sliding screen door. The device may further include a dial connected to the torsion member and the cover; whereby rotation of the dial adjusts the torque in the torsion member.

In another aspect, some configurations of the disclosed subject matter provide a method for closing a sliding screen door. The method includes connecting the cover to a stationary member, and connecting the pulling member to a sliding screen door. The method further includes sliding the sliding screen door to an open position; whereby a torque is created in the torsion member. The method may further include releasing the sliding screen door; whereby the sliding screen door is moved from the open position to a closed position by a linear force created in the pulling member through rotation of the rotating member by the torque in the torsion member.

### BRIEF DESCRIPTION OF THE DRAWINGS

The drawings constitute a part of this specification and include exemplary embodiments of the disclosed subject matter and illustrate various objects and features thereof.

FIG. 1. is an isometric view of an embodiment of the disclosed subject matter.

FIG. 2 is a side view of an embodiment of the disclosed subject matter.

FIG. 3 is a front view of an embodiment of the disclosed subject matter.

FIG. 4 is an exploded view of an embodiment of the disclosed subject matter.

FIG. 5 is a cross section of an embodiment of the disclosed subject matter.

FIG. 6 is a front view of an embodiment of the disclosed subject matter.

FIG. 7 is a flow chart of a method of use of an embodiment of the disclosed subject matter.

FIG. 8 is a flow chart of a method of use of an embodiment of the disclosed subject matter.

### DETAILED DESCRIPTION

As required, detailed aspects of the disclosed subject matter are disclosed herein; however, it is to be understood that the disclosed aspects are merely exemplary of the disclosed subject matter, which may be embodied in various forms. Therefore, specific structural and functional details disclosed herein are not to be interpreted as limiting, but merely as a basis for the claims and as a representative basis for teaching one skilled in the art how to variously employ the disclosed technology in virtually any appropriately detailed structure.

Certain terminology will be used in the following description, and are shown in the drawings, and will not be limiting. For example, up, down, front, back, right and left refer to the disclosed subject matter as orientated in the view being referred to. The words, “inwardly” and “outwardly” refer to directions toward and away from, respectively, the geometric center of the aspect being described and designated parts thereof. Said terminology will include the words specifically mentioned, derivatives thereof and words of similar meaning.

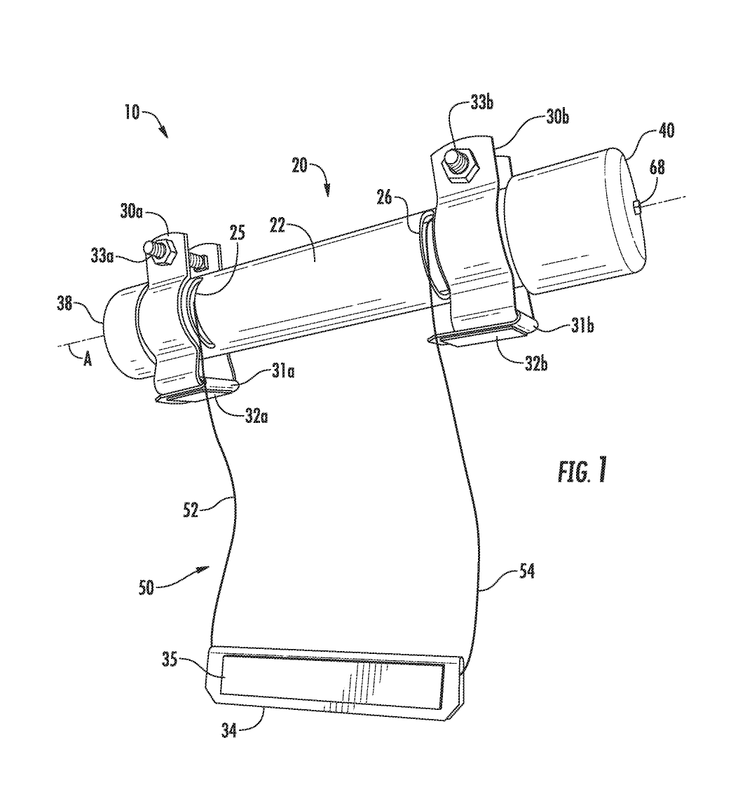

Referring to the drawings, FIGS. 1-4 show an embodiment of disclosed subject matter comprising a closing device 10. The closing device 10 comprising: a substantially tubular cover 20; a rotating member 80 disposed at least partially inside the cover 20; a torsion member 70 connected between the cover 20 and the rotating member 80; and a pulling member 50 received at least partially into the cover 20; the pulling member 50 connected to the rotating member 70; whereby extension of the pulling member 50 away from the cover 20 adjusts a torque in the torsion member 70.

In a preferred embodiment of the disclosed subject matter, the device 10 may further comprise a dial 40 connected to the torsion member 70. The dial 40 rotatably connected to the cover 20 near a lower cover distal end 24; whereby rotation of the dial 40 may adjust the torque in the torsion member 70. The device 10 may further comprise a top cap 38 connected to the cover 20 near an upper cover distal end 23.

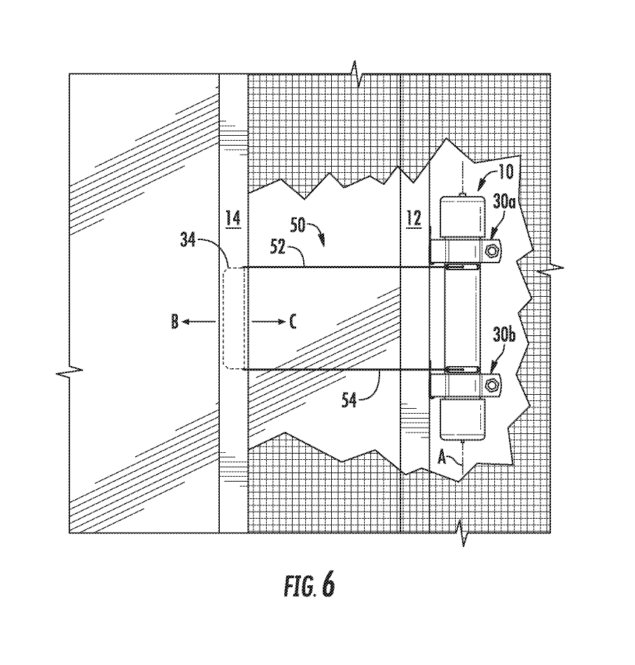

In some embodiments of the disclosed subject matter, the device 10 may be demountable attached to a stationary member 12 such as a glass panel sash edge (shown in FIG. 6) by means of brackets 30a,30b that are connected to the cover 20 and removable attached to braces 31a,31b. The braces 31a,31b may be connected to the stationary member 12 by a double-sided adhesive tape 32a,32b in a manner that the cover 20 can be removed from the braces 31a,31b without removing the brackets 30a,30b from the cover 20. In some embodiments of the disclosed subject matter, the brackets 30a,30b may be c-clamps wherein the brackets 31a,31b are compressed to the cover 20 with a nut and bolt assembly 33a,33b. It is appreciated that other means of securing the brackets 30a,30b to the cover 20 are well known in the art, including, but not limited to adhesives, snaps, welds, and/or claps. In some embodiments of the disclosed subject matter, the brackets 30a,30b and braces 31a,31b may be constructed from a rust-resistant material including, but not limited to, galvanized steel, aluminum, PVC, and/or fiberglass.

In some embodiments of the disclosed subject matter, the device 10 is preferable dimensioned to fit between a stationary member 12 and a sliding screen door 14 (shown in FIG. 6). In a preferred embodiment of the disclosed subject matter, the cover 20, top cap 38, and dial 40 are constructed of polyvinyl chloride (PVC) pipe (schedule 40). The cover 20 preferably has an outside diameter of 1.315 inches and a minimum wall thickness of 0.133 inches. It is appreciated that the cover 20 may take the shape of a square tube or other suitably-dimensioned shape or size. The cover 20, top cap 38 and dial 40 may be constructed from a rust-resistant materials including, but not limited to, plastic, copper, galvanized steel, aluminum, and/or fiberglass.

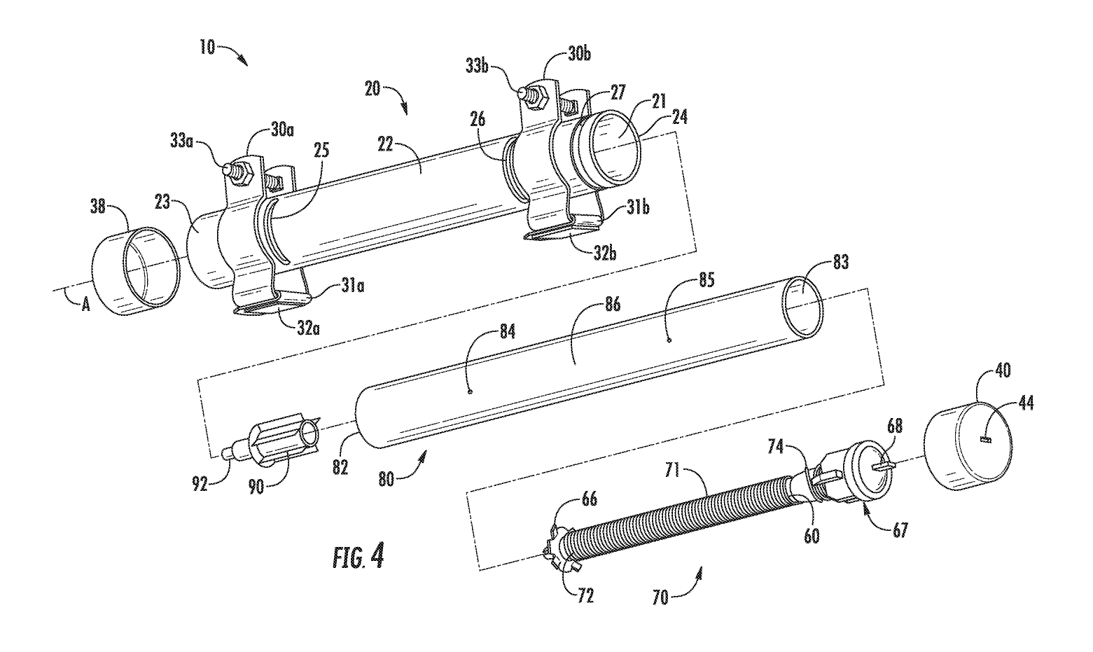

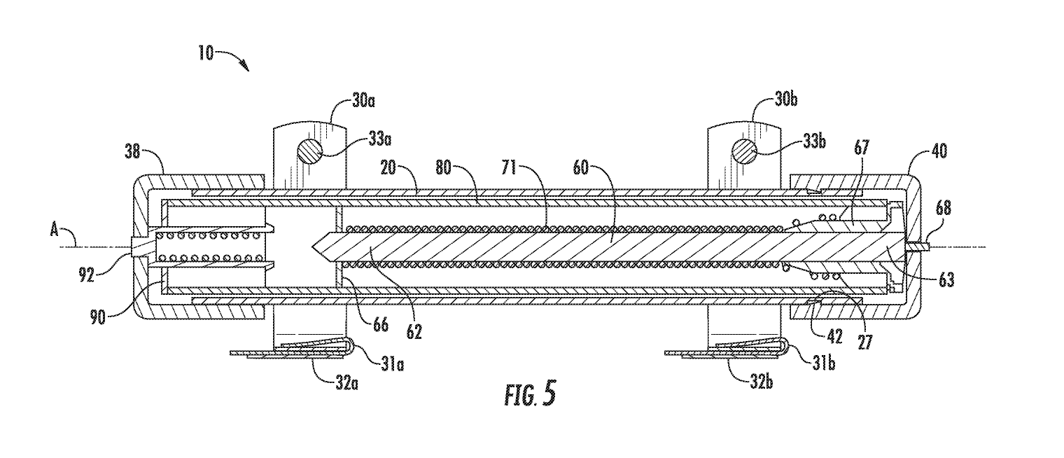

Referring to the drawings, FIGS. 4 and 5, in some embodiments of the disclosed subject matter, the dial 40 may be rotatably attached to the cover 20 by a tongue 42, disposed internal to the dial 40, and a rectangular groove 27 disposed upon the exterior surface 22 of the cover 20 near the lower cover distal end 24.

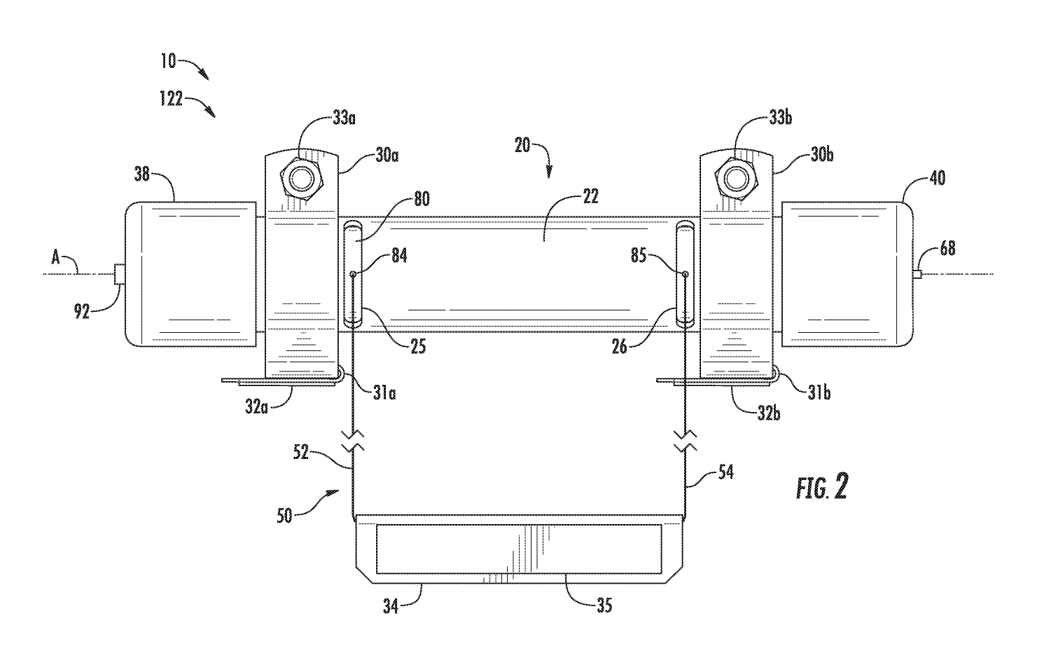

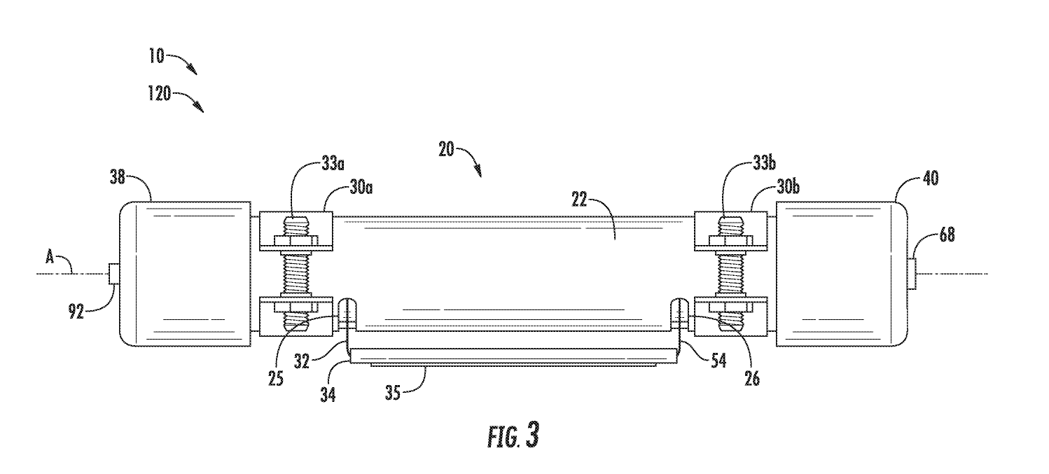

Referring to FIGS. 1-3 of the drawings, in some embodiments of the disclosed subject matter, wherein the closing device 10 further comprises a clasp 34 demountably connected the pulling member 50. The clasp 34 may be attached to the sliding screen door 14 with double-sided adhesive tape 35 or other suitable attachment means including, but not limited to, glue, snaps, welds, claps, and/or nuts and bolts. The clasp 34 may be configured and dimensioned so the pulling member 50 is looped around the clasp 34, forming a first distal end 52 and a second distal end 54. In some embodiments of the disclosed subject matter, the first distal end 52 may be parallel to the second distal end 54 of the pulling member 50 when the pulling member 50 is extended away from the cover 20 from a first position 120 (FIG. 3) to a second position 122 (FIG. 2). A first torque is present in the torsion member 70 when the pulling member 50 is in the first position 120, and a second torque is present in the torsion member 70 when the pulling member 50 is in the second position 122.

In some embodiments of the disclosed subject matter, in order to assist in a balanced opening and closing of the sliding screen door 14, the clasp 34 is attached to the sliding screen door 14 at a height at which the first distal end 52 and second distal end 54 are generally horizontal when extended away from the cover 20. The clasp 34 may be constructed from a rust-resistant material including, but not limited to, galvanized steel, aluminum, plastic, and/or fiberglass.

In some embodiments of the disclosed subject matter, the clasp 34 may be configured and dimensioned so the first distal end 52 and the second distal end 54 form an acute angle or obtuse angle (not shown) with each other when pulling member 50 is extended away from the cover 20. In a preferred embodiment of the disclosed subject matter, the clasp 34 is dimensioned so that the first distal end 52 and the second distal end 54 of pulling member 50 are approximately 4 inches apart. In a preferred embodiment of the disclosed subject matter, the pulling member 50 may be 90 inches long. In some embodiments of the disclosed subject matter, the pulling member 50 may comprise a cord.

Referring to FIG. 4 of the drawings, in some embodiments of the disclosed subject matter, the cover 20 comprises two slits 25,26 extending the thickness of the cover and disposed approximately an equal distance from the upper cover distal end 23 and lower cover distal end 24. The slits 25,26 are preferably spaced a distance of 4 inches apart from each other and aligned perpendicular to the central axis of the cover 20. The width of the slits 25,26 is preferably at least 0.15 inches and the length of the slits 25,26 is preferably 1.0 inch. The slits 25,26 are sized to avoid binding of the pulling member 50 when the pulling member 50 is extended into or retracted out of a cavity formed between the cover 20 and the rotating member 80.

Referring to FIGS. 4-5 of the drawings, the torsion member 70 may further comprise: a torsion spring 71 connected to the rotating member 80; and a dowel 60 having an upper dowel distal end 62 and a lower dowel distal end 63, the dowel 60 disposed at least partially inside the torsion spring 71, the upper dowel distal end 62 connected to the torsion spring 71, the lower dowel distal end 63 connected to the cover 20. In some embodiments of the disclosed subject matter, the lower distal end 63 may be connected to the cover 20 by means of a key 68 disposed within a slot 44 of the dial 40.

Referring to FIGS. 4 and 5 of the drawings, in some embodiments of the disclosed subject matter, the torsion member 70 may further comprise an upper spacer 66 and a lower spacer 67. The upper spacer 66 and lower spacer 67 may be rotatably connected to the dowel 60. The upper spacer 66 and the lower spacer 67 may axially position the dowel 60 within the rotating member 80. The upper spacer 66 may be located near the upper dowel distal end 62, and the lower spacer 67 may be located near the lower dowel distal end 63.

Referring to FIG. 5 of the drawings, in some embodiments of the disclosed subject matter, the torsion spring 71 comprising an upper spring distal end 72 and a lower spring distal end 74 may be axially positioned around the dowel 60. In a preferred embodiment of the disclosed subject matter, the torsion spring 71, in an un-torqued state, may have a length of 4.0 inches, an outside diameter of 0.525 inches, and a spring thickness of 0.034 inches. The upper spring distal end 72 may be connected to the dowel 60 near the upper dowel distal end 62. The lower spring distal end 74 may be connected to the lower spacer 67. In this preferred configuration, the axial rotation of the dowel 60 relative to the lower spacer 67 imparts a torque on the torsion spring 71 because the torsion spring 71 is connected to the dowel 60 near the upper dowel distal end 62 and the lower spacer 67. In a similar manner, since the lower spacer 67 is attached to the torsion spring 71, axial rotation of the dowel 60 relative to the rotating member 80 imparts a torque on the torsion spring 71.

In some embodiments of the disclosed subject matter, when the rotating member 80 is restrained from rotating relative to the cover 20, the torsion spring 71 may be torqued by axially rotating the dial 40 relative to the cover 20 because dowel 60 is connected to the dial 40 via key 68. The torque on the torsion member 70 may be adjusted from a third torque to a fourth torque by restraining the rotating member 80 with the pulling member 50 and axially rotating dial 40 relative to the cover 20 from a first dial position to a second dial position (not shown).

Referring to FIG. 4, in some embodiments of the disclosed subject matter, the rotating member 80 comprising: an exterior surface 86; an upper end 82; a lower end 83; and two holes 84,85 disposed upon the exterior surface 86. The holes 84,85 are dimensioned to accept the thickness of the pulling member 50 and penetrate the thickness of rotating member 80. The holes 84,85 are spaced approximately 4 inches apart from each other along a central axis of the exterior surface 86 and are aligned with the slits 25,26 in the cover 20 so the pulling member 50 may extend through the slits 25,26 and pass directly through the holes 84,85. In a preferred embodiment of the disclosed subject matter, the holes 84,85 may have a diameter of 0.10 inch. The rotating member 80 may have the shape of a cylinder and be constructed of ¾″, SDR-21 pressure pipe having an outside diameter of 1.050 inches, a minimum wall thickness of 0.06 inches, and a length of approximately 8 inches. The rotating member 80 may be constructed from a rust-resistant materials including, but not limited to, plastic, copper, galvanized steel, aluminum, and/or fiberglass.

Referring to FIGS. 4 and 5, in some embodiments of the disclosed subject matter, wherein the device 10 further comprises a compression cap 90 having a spring-loaded member 92 rotatably connected to the top cap 38 at the central axis is rotation A; whereby the rotating member 80 is axially compressed between the compression cap 90 and the dial 40.

Referring back to FIG. 2, in some embodiments of the disclosed subject matter, the first distal end 52 of pulling member 50 may be secured to the rotating member 80 by passing the first distal end 52 through the slit 25 and hole 84 and then providing a first knot (not shown) interior to the rotating member 80. In the same manner, the second distal end 54 of the pulling member 50 may be secured to rotating member 80 by passing the second distal end 54 through slit 26 and hole 85 and then providing a second knot (not shown) interior to the rotating member 80. The first knot at the first distal end 52 may be further secured by compressing the first distal end 52 between the rotating member 80 and the compression cap 90. Similarly, the second knot at the second distal end 54 may be further secured by compressing the second distal end 54 between the rotating member 80 and the lower spacer 67. Other means of attachment of the pulling member 50 to the rotating member 80 may include, but are not limited to, adhesives or screws. In a preferred embodiment of the disclosed subject matter, the pulling member 50 may have a tensile strength of approximately 100 pounds.

Referring to FIG. 6, in some embodiments of the disclosed subject matter, the cover 20 may secured to a stationary member 12 by at least one bracket, but preferably two brackets 30a,30b. In some embodiments of the disclosed subject matter, the center of cover 20 is mounted to the stationary member 12 at a height approximately level with a handle (not shown) of the sliding screen door 14 in order to assist in a balanced operation of the sliding screen door 14. The pulling member 50 may be demountably attached to a sliding screen door 14 by means of a clasp 34 attached to the sliding screen door 14. In some embodiments of the disclosed subject matter, the first distal end 52 and second distal end 54 may be parallel to each other when the clasp 34 is attached to the sliding screen door 14. In some embodiments of the disclosed subject matter, when the sliding screen door 14 moves in a direction B away from cover 20, clasp 34 pulls the pulling member 50 a similar distance away from cover 20 towards direction B at a generally perpendicular angle from the central axis of rotation A. A movement of pulling member 50 from a first position 120 (FIG. 3) towards direction B to a second position 122 (FIG. 2) imparts a rotation upon rotating member 80 and in turn adjusts a spring torque in the torsion spring 71. In some embodiments of the disclosed subject matter, additional spring torque is developed within torsion spring 71 the further the sliding screen door 14 is opened towards direction B. When the sliding screen door 14 is released, the spring torque present at the time of release rotates the rotating member 80 within the cover 20, whereby the pulling member 50 is wrapped around the exterior surface 86 of the rotating member 80 resulting in movement of the sliding screen door 14 towards direction C until the sliding screen door 14 is closed. In a preferred embodiment of the disclosed subject matter, the device 10 is capable of developing a closing force in the range of 1 to 4 pounds between the clasp 34 and the cover 20.

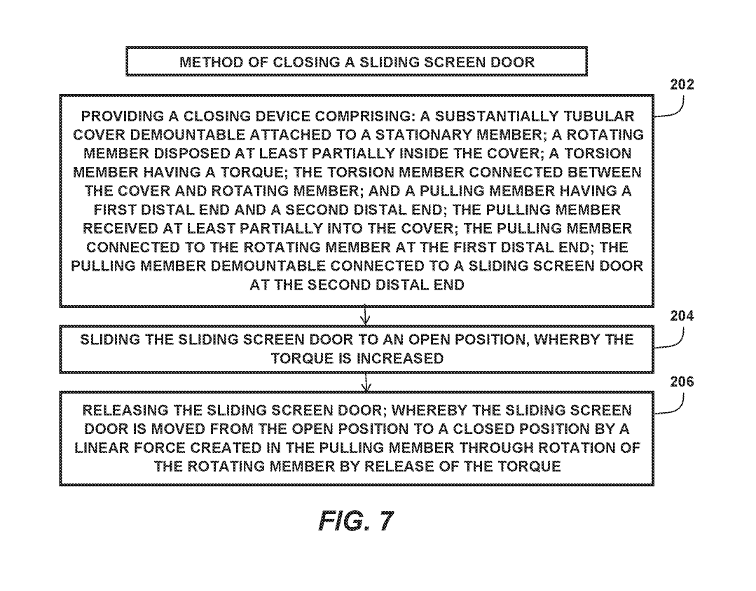

Referring to FIG. 7, in some embodiments of the disclosed subject matter, a method for closing a sliding screen door comprising the steps of: providing a closing device comprising: a substantially tubular cover demountable attached to a stationary member; a rotating member disposed at least partially inside the cover; a torsion member having a torque; the torsion member connected between the cover and rotating member; and a pulling member having a first distal end and a second distal end; the pulling member received at least partially into the cover; the pulling member connected to the rotating member at the first distal end; the pulling member demountable connected to a sliding screen door at the second distal end (step 202); sliding the sliding screen door to an open position; whereby the torque is increased (step 204); and releasing the sliding screen door; whereby the sliding screen door is moved from the open position to a closed position by a linear force created in the pulling member through rotation of the rotating member by release of the torque (step 206).

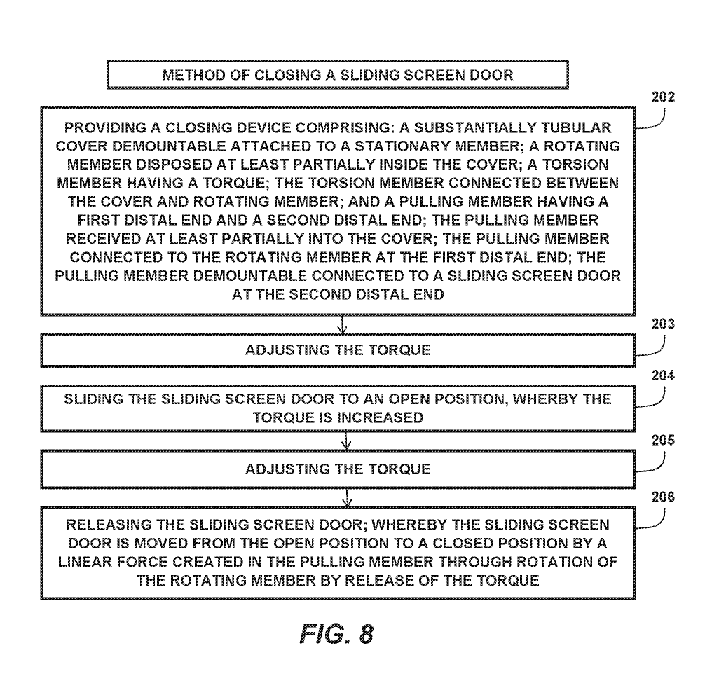

Referring to FIG. 8 of the drawing, in some embodiments of the disclosed subject matter it may be desirable to adjust the torque of the torsion member before opening the sliding screen door, after opening the sliding screen door, or both. Therefore, the method of closing a sliding screen door further comprises the step of adjusting the torque prior to the sliding step (step 203), adjusting the torque prior to the releasing step (step 205), or both. In some embodiments of the disclosed subject matter, step 203, step 205, or both may be eliminated if a preferred torque is present in the torsion member or if no torque adjustment is necessary.

It is to be understood that while certain aspects of the disclosed subject matter have been shown and described, the disclosed subject matter is not limited thereto and encompasses various other embodiments and aspects.

Having described the disclosed subject matter, what is claimed as new and desired to be secured by Letters Patent is:

1. A closing device comprising:
a substantially tubular cover;
a rotating member disposed at least partially inside the cover;
a torsion member connected between the cover and the rotating member; and
a pulling member received at least partially into the cover; the pulling member connected to the rotating member;
whereby extension of the pulling member away from the cover adjusts a torque in the torsion member to affect a closing.

2. The closing device of claim 1, wherein the cover comprising at least one slit configured to receive the pulling member.

3. The closing device of claim 1, wherein the torsion member comprises:
a torsion spring connected to the rotating member; and
a dowel having an upper dowel distal end and a lower dowel distal end, the dowel disposed at least partially inside the torsion spring, the upper dowel distal end connected to the torsion spring, the lower dowel distal end connected to the cover.

4. The closing device of claim 1, wherein the torsion member further comprises at least one spacer rotatably connected to the dowel.

5. The closing device of claim 1, wherein the device further comprises a dial connected to the torsion member and the cover; whereby rotation of the dial adjusts the torque.

6. The closing device of claim 5, wherein the device further comprises a compression cap; whereby the rotating member is axially compressed between the compression cap and the dial.

7. The closing device of claim 1, wherein the rotating member comprises a cylinder.

8. The closing device of claim 1, wherein the pulling member comprises a cord.

9. The closing device of claim 8, wherein the cord is dimensioned to wrap around an exterior surface of the rotating member within a cavity disposed between the exterior surface and an interior surface of the cover.

10. The closing device of claim 1, wherein the closing device further comprises a clasp demountably connected the pulling member.

11. The closing device of claim 1, wherein the closing device further comprises at least one bracket connected to the cover.

12. The closing device of claim 2, wherein the at least one slit comprises a first slit and a second slit.

13. A closing device comprising:
a substantially tubular cover comprising: at least one slit disposed on an exterior surface of the cover; and a lower cover distal end;
a dial rotatably connected to the lower cover distal end;
a cylinder disposed at least partially inside the cover;
a torsion spring having a spring torque; the torsion spring disposed inside the cylinder;
a dowel having an upper dowel end and a lower dowel distal end, the dowel disposed at least partially inside the torsion spring, the upper dowel distal end connected to the torsion spring, the lower dowel distal end connected to the dial; whereby rotation of the dial relative to the cover adjusts the spring torque to affect a closing; and
a cord received at least partially into the cover through the at least one slit; the cord connected to and wrapped around an exterior surface of the cylinder; whereby extension of the cord away from the cover adjusts the spring torque to further affect the closing.

14. The closing device of claim 13, wherein the cord is demountably connected to a clasp.

15. The closing device of claim 13, wherein the cover further comprises at least one bracket demountably connected to the cover.

16. A method of automatically closing a sliding screen door comprising the steps of:
providing a closing device comprising:
a substantially tubular cover demountable attached to a stationary member;
a rotating member disposed at least partially inside the cover;
a torsion member having a torque; the torsion member connected between the cover and rotating member; and
a pulling member having a first distal end and a second distal end; the pulling member received at least partially into the cover; the pulling member connected to the rotating member at the first distal end; the pulling member demountable connected to a sliding screen door at the second distal end;
sliding the sliding screen door to an open position; whereby the torque is increased; and
releasing the sliding screen door; whereby the sliding screen door is moved from the open position to a closed position by a linear force created in the pulling member through rotation of the rotating member by release of the torque.

17. A method of automatically closing a sliding screen door of claim 16, further comprising the step of adjusting the torque prior to the sliding step.

18. A method of automatically closing a sliding screen door of claim 17, further comprising the step of adjusting the torque prior to the releasing step.

19. A method of automatically closing a sliding screen door of claim 16, further comprising the step of adjusting the torque prior to the releasing step.
